(19) United States
(12) Patent Application Publication
(10) Pub. No.: US 2026/0229378 A1
(43) Pub. Date: Aug. 6, 2026

(54) TWO-STEP CHLORIDE VOLATILITY PROCESS FOR SEPARATING URANIUM AND TRANSURANIC ELEMENTS FROM RADIOACTIVE WASTE

(71) Applicant: BRIGHAM YOUNG UNIVERSITY, Provo, UT (US)

(72) Inventor: Devin Rappleye, Lindon, UT (US)

(73) Assignee: BRIGHAM YOUNG UNIVERSITY, Provo, UT (US)

(21) Appl. No.: 19/046,662

(22) Filed: Feb. 6, 2025

(51) Int. Cl. G21C 19/48

(52) U.S. Cl. CPC G21C 19/48

(57) ABSTRACT

Disclosed is a method for separating elements from used nuclear fuel. This includes positioning a quantity of used nuclear fuel in a hot zone of a chamber and introducing a hydrogen chloride gas stream to the used nuclear fuel in the hot zone. Also includes, vaporizing a portion of the used nuclear fuel and depositing the portion of the vaporized nuclear fuel in a cold zone of the chamber. Then the method includes, introducing a chloride gas to a residual used nuclear fuel that remains after vaporizing the portion of the used nuclear fuel and vaporizing a portion of the residual used nuclear fuel in the hot zone. Then ultimately, depositing the vaporized portion of the residual used nuclear fuel on the cold zone of the chamber.

### BACKGROUND.

This application claims the priority and benefit of United States Provisional Patent Application No. 64/228,413 filed on Feb. 6, 2024, which is incorporated by reference in its entirety.

The separation of uranium and transuranic elements from radioactive waste has been a critical area in nuclear technology. This separation is essential for reducing the long-term radiotoxicity of nuclear waste, recycling valuable actinides, and ensuring the safe disposal of residual waste. Over time, several processes have been developed to address these objectives, each with its own benefits and limitations.

Historical Processes for Separating Uranium and Transuranic Elements include the PUREX Process (Plutonium Uranium Redox Extraction). The PUREX process, developed in the mid-20th century, became the most widely used method for separating uranium and plutonium from spent nuclear fuel. It uses a liquid-liquid extraction technique with an organic solvent, typically tributyl phosphate (TBP) dissolved in kerosene or a similar diluent, to selectively extract uranium and plutonium from nitric acid solutions of dissolved spent fuel.

The PUREX process is inefficient for separating minor actinides (e.g., neptunium, americium, curium) from fission products. Further, PUREX generates large volumes of secondary liquid radioactive waste requiring further treatment. Also, there is limited ability to address advanced fuel cycles, including those using thorium or other non-traditional fuels. Additionally, PUREX entails high operational complexity and cost when used in large-scale implementation.

Another process used is the TRUEX Process (Transuranic Extraction). The TRUEX process was introduced to extract transuranic elements such as americium and curium in addition to uranium and plutonium. It utilizes an organic solvent containing CMPO (octyl(phenyl)-N, N-diisobutylcarbamoylmethylphosphine oxide) mixed with TBP (Tributyl Phosphate) to achieve broader actinide separation from fission products. While effective at extracting transuranics, the process still suffers from high chemical complexity, requiring multiple stages to achieve adequate purity. The use of specialized reagents increases cost and introduces challenges in reagent stability and reuse. Moreover, residual fission products, including lanthanides, remain difficult to completely remove due to their chemical similarity to actinides.

DIAMEX Process (Diamide Extraction) was developed to improve upon the limitations of PUREX and TRUEX by employing diamide-based extractants, which are more selective for actinides. This process also minimizes the use of phosphorus-based solvents, reducing secondary waste challenges. The DIAMEX process reduces the issue of solvent degradation compared to previous methods but still requires significant solvent cleanup and disposal infrastructure. Additionally, DIAMEX has limited scalability and operational experience as compared to PUREX. The separation of minor actinides from lanthanides remains challenging, necessitating additional separation techniques.

Pyroprocessing methods, also known as electrochemical separation, involve dissolving spent nuclear fuel in molten salts (e.g., lithium chloride-potassium chloride) and using electrochemical techniques to separate uranium and transuranic. This method is particularly suited to advanced reactor systems, such as fast reactors, which can recycle actinides as fuel. High-temperature operations introduce material and equipment durability challenges. Limited ability to fully separate specific actinides from lanthanides in a single step. The technology is still in a developmental stage, with limited large-scale industrial applications. Also, pyroprocessing requires expensive infrastructure and includes potential challenges in handling molten salts and reactive metals.

### SUMMARY OF THE DISCLOSURE

Disclosed herein is a two-step chloride volatility process for separating uranium and transuranic elements from radioactive waste.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. The advantages of the disclosure will become better understood with regard to the following description and accompanying drawings where:

FIG. 1 illustrates a diagram of a two-step chloride volatility process.

FIG. 2 illustrates a method of a two-step chloride volatility process with respect to molten salt reactors, sodium fast reactors, and light water reactors.

FIG. 3 illustrates a diagram of step one of a two-step chloride volatility process along with a graphical representation.

FIG. 4 illustrates a diagram of step two of a two-step chloride volatility process along with a graphical representation.

### DETAILED DESCRIPTION

In the following description of the disclosure, reference is made to the accompanying drawings, which form a part hereof, and which are shown by way of illustration-specific implementations in which the disclosure may be practiced. It is understood that other implementations may be utilized, and structural changes may be made without departing from the scope of the disclosure.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure may be alternatively included in another embodiment or figure regardless of whether or not those elements are shown or described in another embodiment or figure. In other words, elements in the figures may be interchangeable between various embodiments disclosed herein, whether shown or not.

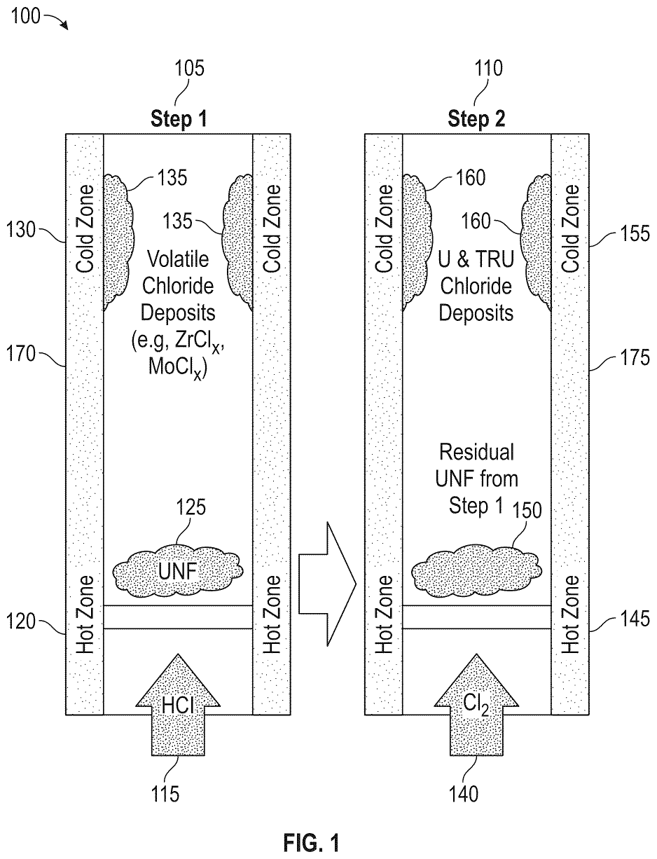

FIG. 1 illustrates a diagram of two-step chloride volatility system 100 that includes chamber 170. In the first step 105, chamber 170 may include hot zone 120 positioned towards one end of chamber 170, and cold zone 130 may be positioned towards another end of chamber 170. The temperatures in hot zone 120 need to be hot enough to vaporize volatile chlorides after coming in contact with hydrogen chloride (“HCl”), if the feed needs to be chlorinated, or an inert gas, such as argon, if the feed is all chloride. The temperatures in cold zone 130 need to be cold enough to allow vaporized volatile chlorides to deposit on the walls of chamber 170. Cold zone 130 portion of chamber 170 may be removably attached to chamber 170. Used nuclear fuel (“UNF”) 125 may be positioned at or near hot zone 120 where hydrogen chloride (“HCl”) or inert gas stream 115 is introduced to used nuclear fuel (“UNF”) 125. Through this process, chlorides may be removed from the nuclear fuel (“UNF”) 125. The vapor created, also known as volatilization, in hot zone 120 through the interaction between used nuclear fuel (“UNF”) 125 and hydrogen chloride (“HCl”) gas may flow towards cold zone 120. The vapor may then deposit volatile chlorides on the surface of chamber 170 in cold zone 130. The volatile chloride deposits 135 may be removed prior to the second step 110.

In the second step 110, chamber 175 includes hot zone 145 positioned towards one end of chamber 175 and cold zone 155 towards another end of chamber 175. The temperatures in hot zone 145 and hot zone 120 need to be hot enough to vaporize uranium (“U”), and transuranic elements (“TRU”) after coming in contact with chlorine (“Cl2”). The temperatures in cold zone 155 need to be cold enough to allow vaporized uranium (“U”), and transuranic elements (“TRU”) to deposit on the walls of chamber 175. Cold zone 155 may be removably attached to chamber 175. Chambers 170 and 175 may be the same chamber such that both first step 105 and the second step 110 may take place in the same chamber. As a result, hot zone 120 may be the same as hot zone 145, and cold zone 130 may be the same as cold zone 155. In the second step 110, residual used nuclear fuel (“UNF”) 150 is positioned near hot zone 145 where chlorine (“Cl₂”) stream passes over residual used nuclear fuel (“UNF”) creating a vapor. The vapor that may include chlorides, uranium (“U”), and transuranic elements (“TRU”) flow towards cold zone 155 where the chlorides, uranium (“U”), and the transuranic elements (“TRU”) are deposited on the surface of chamber 175. Afterward, the chlorides, uranium (“U”), and the transuranic elements (“TRU”) may be subjected to electrowinning to extract, uranium (“U”), and the transuranic elements (“TRU”).

Two-step chloride volatility process 100 may be used to exploit the tendency of uranium (“U”) and plutonium (“Pu”) to form higher chlorides in the presence of chlorine gas by first chlorinating and volatilizing used nuclear fuel (“UNF”) in hydrogen chloride (“HCl”) or inert gas then Cl2 gas. Under hydrogen chloride (“HCl”) or inert gas, volatile fission products (“FP”) are removed from used nuclear fuel (“UNF”). Then, uranium (“U”) plutonium (“Pu”), and other transuranic elements (“TRU”) are volatilized and removed from used nuclear fuel (“UNF”) under chlorine gas (“Cl₂”) due to the formation of higher chlorides of uranium (“U”) and plutonium (“Pu”) which are more volatile.

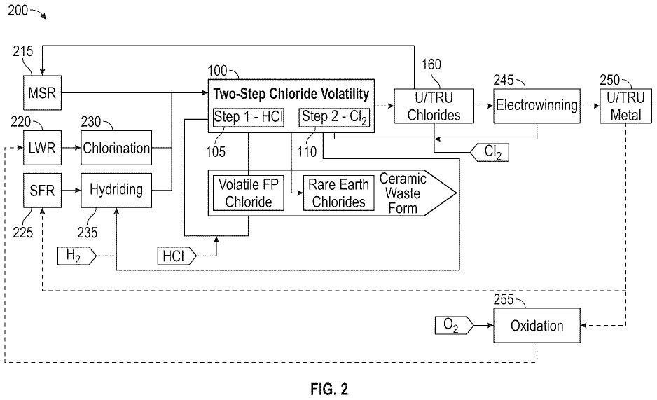

FIG. 2 illustrates method 200 of using two-step chloride volatility process 100 with used nuclear fuel (“UNF”) 125 from molten salt reactors (“MSR”) 215, light water reactors (“LWR”) 220, and sodium fast reactors (“SFR”) 225. Using method 200 to treat used nuclear fuel (“UNF”) 125 from molten salt reactors (“MSR”) 215 may not require any preliminary actions before beginning the two-step Chloride Volatility process 100. Accordingly, first step 105 as depicted in FIG. 1 includes a chamber 170 that includes hot zone 120 positioned towards one end of chamber 170 and cold zone 130 positioned towards another end of chamber 170. The temperatures in hot zone 120 need to be hot enough to vaporize volatile chlorides after coming in contact with hydrogen chloride (“HCl”), if the feed needs to be chlorinated, or an inert gas, such as argon, if the feed is all chloride. The temperatures in cold zone 130 need to be cold enough to allow vaporized volatile chlorides to deposit on the walls of chamber 170. Cold zone 130 portion of chamber 170 may be removably attached to chamber 170. Used nuclear fuel (“UNF”) 125 may be positioned at or near hot zone 120 where hydrogen chloride (“HCl”) or inert gas stream 115 is introduced to used nuclear fuel (“UNF”) 125. Through this process, chlorides may be removed from the nuclear fuel (“UNF”) 125. The vapor created, also known as volatilization, in hot zone 120 through the interaction between used nuclear fuel (“UNF”) 125 and hydrogen chloride (“HCl”) gas may flow towards cold zone 120. The vapor may then deposit volatile chlorides on the surface of chamber 170 in cold zone 130. The volatile chloride deposits 135 may be removed prior to the second step.

Then the residual used nuclear fuel (“UNF”) 150 from molten salt reactors (“MSR”) 215 proceeds to the second step 210. The second step 110 as depicted in FIG. 1 includes chamber 175 includes hot zone 145 positioned towards one end of chamber 175 and cold zone 155 positioned towards another end of chamber 175. The temperatures in hot zone 145 need to be hot enough to vaporize uranium (“U”), and transuranic elements (“TRU”) after coming in contact with chlorine (“Cl2”). The temperatures in cold zone 155 may need to be cold enough to allow vaporized uranium (“U”), and transuranic elements (“TRU”) to deposit on the walls of chamber 175. Cold zone 155 may be removably attached to chamber 175. Chambers 170 and 175 may be the same chamber. As a result, hot zone 120 may be the same as hot zone 145, and cold zone 130 may be the same as cold zone 155. In the second step 110, residual used nuclear fuel (“UNF”) 150 from molten salt reactors (“MSR”) 215 may be positioned near hot zone 145 where chlorine (“Cl₂”) stream passes over residual used nuclear fuel (“UNF”) creating a vapor. The vapor that includes chloride deposits, uranium (“U”), and transuranic elements (“TRU”) flow towards cold zone 155 where the uranium (“U”) and the transuranic elements (“TRU”) may be deposited on the surface of chamber 175 within cold zone 155. Accordingly, with cold zone 155 being removable from chamber 175 chloride deposits uranium (“U”) and transuranic elements (“TRU”) deposit 160 may be removed at this time.

Using method 200 to treat used nuclear fuel (“UNF”) 125 from light water reactors (“LWR”) 220 may require preliminary actions before beginning the two-step chloride volatility process 100. With light water reactors (“LWR”) 220 a preliminary step of chlorination 230 may occur before more commonly used steps of the two-step chloride volatility process 100. After chlorination, two-step chloride volatility 100 may proceed. Then the used nuclear fuel (“UNF”) 125 from light water reactors (“LWR”) 220 proceeds to the first step 105. First step 105 is similar to the first step 105 as depicted in FIG. 1 that includes a chamber 170 that includes hot zone 120 towards one end of chamber 170 and cold zone 130 towards another end of chamber 170. The temperatures in hot zone 120 need to be hot enough to vaporize volatile chlorides after coming in contact with hydrogen chloride. The temperatures in hot zone 120 need to be hot enough to vaporize volatile chlorides after coming in contact with hydrogen chloride (“HCl”), if the feed needs to be chlorinated, or an inert gas, such as argon, if the feed is all chloride. The temperatures in cold zone 130 need to be cold enough to allow vaporized volatile chlorides to deposit on the walls of chamber 170. Cold zone 130 portion of chamber 170 may be removably attached to chamber 170. Used nuclear fuel (“UNF”) 125 may be positioned at or near hot zone 120 where hydrogen chloride (“HCl”) or inert gas stream 115 is introduced to used nuclear fuel (“UNF”) 125. Through this process, chlorides may be removed from the nuclear fuel (“UNF”) 125. The vapor created, also known as volatilization, in hot zone 120 through the interaction between used nuclear fuel (“UNF”) 125 and hydrogen chloride (“HCl”) gas may flow towards cold zone 120. The vapor may then deposit volatile chlorides on the surface of chamber 170 in cold zone 130. The volatile chloride deposits 135 may be removed prior to the second step.

Then the residual used nuclear fuel (“UNF”) 125 from light water reactors (“LWR”) 220 proceeds to the second step 110. The second step 110 as depicted in FIG. 1 includes chamber 175 includes hot zone 145 positioned towards one end of chamber 175 and cold zone 155 positioned towards another end of chamber 175. The temperatures in hot zone 145 need to be hot enough to vaporize uranium (“U”), and transuranic elements (“TRU”) after coming in contact with chlorine (“Cl2”). The temperatures in cold zone 155 need to be cold enough to allow vaporized uranium (“U”), and transuranic elements (“TRU”) to deposit on the walls of chamber 175. Cold zone 155 may be removably attached to chamber 175. Chambers 170 and 175 may be the same chamber. As a result, hot zone 120 may be the same as hot zone 145, and cold zone 130 may be the same as cold zone 155. In the second step 110, residual used nuclear fuel (“UNF”) 150 from light water reactors (“LWR”) 220 may be positioned near hot zone 145 where chlorine (“Cl₂”) stream passes over residual used nuclear fuel (“UNF”) creating a vapor. The vapor that includes chloride deposits, uranium (“U”), and transuranic elements (“TRU”) flow towards cold zone 155 where the uranium (“U”) and the transuranic elements (“TRU”) may be deposited on the surface of chamber 175 within cold zone 155. Accordingly, with cold zone 155 being removable from chamber 175 chloride deposits uranium (“U”) and transuranic elements (“TRU”) deposit 160 may be removed at this time.

Using method 200 to treat used nuclear fuel (“UNF”) 125 from sodium fast reactors (“SFR”) 225 may require preliminary actions before beginning the two-step Chloride Volatility process 100. With sodium fast reactors (“SFR”) 225 a preliminary step of hydriding 235 may occur before the two-step chloride volatility process 100. After chlorination, two-step chloride volatility 100 may proceed. Then the used nuclear fuel (“UNF”) 125 from sodium fast reactors (“SFR”) 225 proceeds to the first step 105. First step 105 is similar to the first step 105 as depicted in FIG. 1 that includes a chamber 170 that includes hot zone 120 towards one end of chamber 170 and cold zone 130 towards another end of chamber 170. The temperatures in hot zone 120 need to be hot enough to vaporize volatile chlorides after coming in contact with hydrogen chloride (“HCl”), if the feed needs to be chlorinated, or an inert gas, such as argon, if the feed is all chloride. The temperatures in cold zone 130 need to be cold enough to allow vaporized volatile chlorides to deposit on the walls of chamber 170. Cold zone 130 portion of chamber 170 may be removably attached to chamber 170. Used nuclear fuel (“UNF”) 125 may be positioned at or near hot zone 120 where hydrogen chloride (“HCl”) or inert gas stream 115 is introduced to used nuclear fuel (“UNF”) 125. Through this process, chlorides may be removed from the nuclear fuel (“UNF”) 125. The vapor created, also known as volatilization, in hot zone 120 through the interaction between used nuclear fuel (“UNF”) 125 and hydrogen chloride (“HCl”) gas may flow towards cold zone 120. The vapor may then deposit volatile chlorides on the surface of chamber 170 in cold zone 130. The volatile chloride deposits 135 may be removed prior to the second step.

Then the residual used nuclear fuel (“UNF”) from sodium fast reactors (“SFR”) 225 may proceed to the second step 210. The second step 110 as depicted in FIG. 1 includes chamber 175 includes hot zone 145 positioned towards one end of chamber 175 and cold zone 155 positioned towards another end of chamber 175. The temperatures in hot zone 145 need to be hot enough to vaporize uranium (“U”), and transuranic elements (“TRU”) after coming in contact with chlorine (“Cl2”). The temperatures in cold zone 155 need to be cold enough to allow vaporized uranium (“U”), and transuranic elements (“TRU”) to deposit on the walls of chamber 175. Cold zone 155 may be removably attached to chamber 175. Chambers 170 and 175 may be the same chamber. As a result, hot zone 120 may be the same as hot zone 145, and cold zone 130 may be the same as cold zone 155. In the second step 110, residual used nuclear fuel (“UNF”) 150 from sodium fast reactors (“SFR”) 225 may be positioned near hot zone 145 where chlorine (“Cl2”) stream passes over residual used nuclear fuel (“UNF”) creating a vapor. The vapor that includes chloride deposits, uranium (“U”), and transuranic elements (“TRU”) flow towards cold zone 155 where the uranium (“U”) and the transuranic elements (“TRU”) may be deposited on the surface of chamber 175 within cold zone 155. Accordingly, with cold zone 155 being removable from chamber 175 chloride deposits uranium (“U”) and transuranic elements (“TRU”) deposit 160 may be removed at this time.

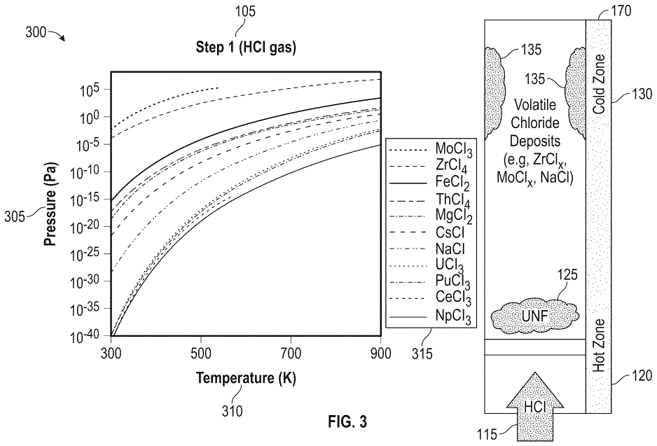

FIG. 3 illustrates a diagram of step one of a two-step chloride volatility process along with a graphical representation. In the first step 105, chamber 170 may include hot zone 120 positioned towards one end of chamber 170, and cold zone 130 may be positioned towards another end of chamber 170. The temperatures in hot zone 120 need to be hot enough to vaporize volatile chlorides after coming in contact with hydrogen chloride The temperatures in hot zone 120 need to be hot enough to vaporize volatile chlorides after coming in contact with hydrogen chloride (“HCl”), if the feed needs to be chlorinated, or an inert gas, such as argon, if the feed is all chloride. The temperatures in cold zone 130 need to be cold enough to allow vaporized volatile chlorides to deposit on the walls of chamber 170. Cold zone 130 portion of chamber 170 may be removably attached to chamber 170. Used nuclear fuel (“UNF”) 125 may be positioned at or near hot zone 120 where hydrogen chloride (“HCl”) or inert gas stream 115 is introduced to used nuclear fuel (“UNF”) 125. Through this process, chlorides may be removed from the nuclear fuel (“UNF”) 125. The vapor created, also known as volatilization, in hot zone 120 through the interaction between used nuclear fuel (“UNF”) 125 and hydrogen chloride (“HCl”) gas may flow towards cold zone 120. The vapor may then deposit volatile chlorides on the surface of chamber 170 in cold zone 130. The volatile chloride deposits 135 may be removed prior to the second step 110.

Some of the compounds extracted may include various compounds 315 such as MoCl₅, ZrCl₄, FeCl₂, ThCl₄, MgCl₂, CsCl, NaCl, UCl₃, PuCl₃, CeCl₃ NpCl₃, etc. These compounds 315 behaved differently as pressure and temperature as depicted in the graphical representation that depicts temperature 310 in Kelvin along the x-axis. Along the y-axis pressure 305 is depicted in Pascals.

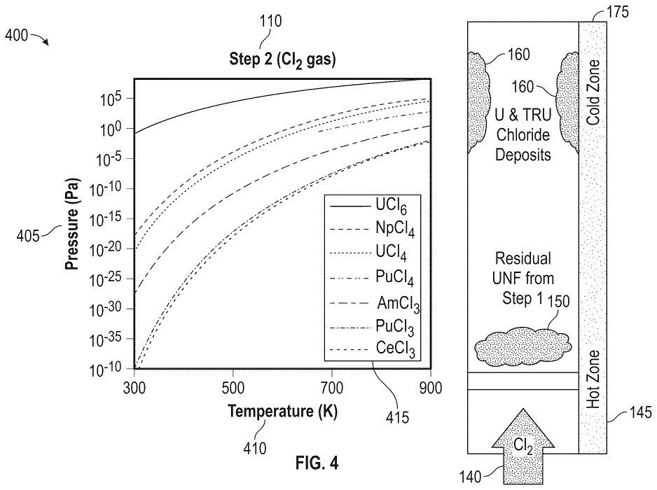

FIG. 4 illustrates a diagram of step two 110 of a two-step chloride volatility process 100 along with a graphical representation 300. The second step 110 as depicted in FIG. 1 includes chamber 175 includes hot zone 145 positioned towards one end of chamber 175 and cold zone 155 positioned towards another end of chamber 175. The temperatures in hot zone 145 need to be hot enough to vaporize uranium (“U”), and transuranic elements (“TRU”) after coming in contact with chlorine (“Cl2”). The temperatures in cold zone 155 need to be cold enough to allow vaporized uranium (“U”), and transuranic elements (“TRU”) to deposit on the walls of chamber 175. Cold zone 155 may be removably attached to chamber 175. Chambers 170 and 175 may be the same chamber. As a result, hot zone 120 may be the same as hot zone 145, and cold zone 130 may be the same as cold zone 155. In the second step 110, residual used nuclear fuel (“UNF”) 150 from sodium fast reactors (“SFR”) 225 may be positioned near hot zone 145 where chlorine (“Cl2”) stream passes over residual used nuclear fuel (“UNF”) creating a vapor. The vapor that includes chloride deposits, uranium (“U”), and transuranic elements (“TRU”) flow towards cold zone 155 where the uranium (“U”) and the transuranic elements (“TRU”) may be deposited on the surface of chamber 175 within cold zone 155. Accordingly, with cold zone 155 being removable from chamber 175 chloride deposits uranium (“U”) and transuranic elements (“TRU”) deposit 160 may be removed at this time.

Some of the compounds extracted may include various compounds 415 such as UCl₆, NpCl₄, UCl₄, PuCl₄, AmCl₃, PuCl₃, CeCl₃, etc. These compounds 415 behaved differently as pressure and temperature as depicted in the graphical representation that depicts temperature 410 in Kelvin along the x-axis. Along the y-axis pressure 405 is depicted in Pascals.

Although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. A method for separating elements from used nuclear fuel comprising:
positioning a quantity of used nuclear fuel in a hot zone of a chamber;
introducing a hydrogen chloride gas or inert gas stream to the used nuclear fuel in the hot zone;
vaporizing a portion of the used nuclear fuel;
depositing of the portion of the vaporized nuclear fuel in a cold zone of the chamber;
introducing a chlorine gas to a residual used nuclear fuel that remains after vaporizing the portion of the used nuclear fuel;
vaporizing a portion of the residual used nuclear fuel in the hot zone; and
depositing the vaporized portion of the residual used nuclear fuel in the cold zone of the chamber.

2. The method of claim 1, wherein the used nuclear fuel comes from molten salt reactors.

3. The method of claim 1, wherein volatile chlorides in the hot zone are vaporized from the used nuclear fuel as a result of being exposed to heat and to hydrogen chloride gas.

4. The method of claim 1, wherein uranium and transuranic elements in the hot zone, as part of the residual used nuclear fuel, are vaporized after being exposed to chlorine.

5. The method of claim 1, wherein the chamber can be heated and pressurized.

6. The method of claim 1, wherein the hot zone is hot enough to vaporize volatile chlorides when the unused nuclear fuel is exposed to hydrogen chloride.

7. The method of claim 1, wherein the cold zone is cold enough to allow one or more of the vaporized volatile chlorides, uranium, or transuranic elements to deposit on the walls of the chamber.

8. A method for separating elements from used nuclear fuel comprising:
positioning a quantity of used nuclear fuel in a hot zone of a chamber;
chlorinating a quantity of the used nuclear fuel;
introducing a hydrogen chloride gas or inert gas stream to the used nuclear fuel in the hot zone;
vaporizing a portion of the used nuclear fuel;
depositing of the portion of the vaporized nuclear fuel in a cold zone of the chamber;
introducing a chlorine gas to a residual used nuclear fuel that remains after vaporizing the portion of the used nuclear fuel;
vaporizing a portion of the residual used nuclear fuel in the hot zone; and
depositing the vaporized portion of the residual used nuclear fuel in the cold zone of the chamber.

9. The method of claim 8, wherein the used nuclear fuel comes from a light water reactor.

10. The method of claim 8, wherein volatile chlorides in the hot zone are vaporized from the used nuclear fuel as a result of being exposed to heat and to hydrogen chloride gas.

11. The method of claim 8, wherein uranium and transuranic elements in the hot zone, as part of the residual used nuclear fuel, are vaporized after being exposed to chlorine.

12. The method of claim 8, wherein the chamber can be heated and pressurized.

13. The method of claim 8, wherein the hot zone is hot enough to vaporize volatile chlorides when the unused nuclear fuel is exposed to hydrogen chloride.

14. The method of claim 8, wherein the cold zone is cold enough to allow one or more of the vaporized volatile chlorides, uranium, or transuranic elements to deposit on the walls of the chamber.

15. A method of separating elements from used nuclear fuel comprising:
positioning a quantity of used nuclear fuel in a hot zone of a chamber;
hydriding a quantity of the used nuclear fuel;
introducing a hydrogen chloride gas or inert gas stream to the used nuclear fuel in the hot zone;
vaporizing a portion of the used nuclear fuel;
depositing of the portion of the vaporized nuclear fuel in a cold zone of the chamber;
introducing a chlorine gas to a residual used nuclear fuel that remains after vaporizing the portion of the used nuclear fuel;
vaporizing a portion of the residual used nuclear fuel in the hot zone; and
depositing the vaporized portion of the residual used nuclear fuel in the cold zone of the chamber.

16. The method of claim 15, wherein the used nuclear fuel comes from a sodium fast reactor.

17. The method of claim 15, wherein volatile chlorides in the hot zone are vaporized from the used nuclear fuel as a result of being exposed to heat and to hydrogen chloride gas.

18. The method of claim 15, wherein uranium and transuranic elements in the hot zone, as part of the residual used nuclear fuel, are vaporized after being exposed to chlorine.

19. The method of claim 15, wherein the hot zone is hot enough to vaporize volatile chlorides when the unused nuclear fuel is exposed to hydrogen chloride.

20. The method of claim 15, wherein the cold zone is cold enough to allow one or more of the vaporized volatile chlorides, uranium, or transuranic elements to deposit on the walls of the chamber.
